(19) United States
(12) Patent Application Publication
(10) Pub. No.: US 2026/0057481 A1
(43) Pub. Date: Feb. 26, 2026

(54) System and Method for Optical Convolutional Image Processing Using Spatial Light Modulation and Photosensitive Kernel-Embedded Film

(71) Applicants: Run Zhou Ye, Rochester, MN (US); En Zhou Ye, Montreal (CA); En Hui Esther Ye, Montreal (CA); Joseph Ye, Montreal (CA); Jacob Ye, Montreal (CA); Bin Zhang, Montreal (CA); Ming Ye, Montreal (CA)

(72) Inventors: Run Zhou Ye, Rochester, MN (US); En Zhou Ye, Montreal (CA); En Hui Esther Ye, Montreal (CA); Joseph Ye, Montreal (CA); Jacob Ye, Montreal (CA); Bin Zhang, Montreal (CA); Ming Ye, Montreal (CA)

(21) Appl. No.: 18/814,584

(22) Filed: Aug. 25, 2024

(51) Int. Cl. G06T 5/20; G03C 5/39

(52) U.S. Cl. CPC G06T 5/20; G03C 5/39

(57) ABSTRACT

The invention provides an optical image processing system that performs convolutional operations using spatially modulated light and a photosensitive film embedded with a convolutional kernel. A spatial light modulator (101), such as a digital micromirror device or LCD panel, emits light corresponding to an input image. This light passes through a photosensitive film (102) embedded with the kernel via a process of photographic exposure, chemical development, and fixing. The modulated light is projected onto an output plane (103), forming the final image, which is the convolution of the input image and the kernel. This image can be captured by a camera for further analysis. The system allows real-time, high-speed image processing by utilizing the properties of light, reducing digital computational requirements, and enabling flexibility through replaceable films for various tasks.

### FIELD OF THE INVENTION

This invention relates to optical image processing systems, and more specifically, to a system and method for performing convolutional image processing using spatially modulated light emitted by a spatial light modulator, such as a digital micromirror device (DMD) or liquid crystal display (LCD) panel, in combination with a photosensitive film embedded with a convolutional kernel.

### BACKGROUND OF THE INVENTION

Convolutional image processing is a fundamental operation in many areas of computer vision and digital image processing, where a kernel (or filter) is convolved with an input image to produce a transformed output image. This process is typically performed digitally using specialized hardware such as GPUs or digital signal processors. However, the computational demands of real-time image processing applications, such as augmented reality and high-definition video processing, have driven the exploration of alternative methods that could leverage the physical properties of light to perform these operations at much higher speeds.

Existing optical systems for image processing, such as Fourier optics, can perform specific mathematical operations using lenses and optical components. However, these systems are often bulky, difficult to calibrate, and lack the flexibility required for general-purpose image processing tasks. A need exists for a compact and flexible optical system that can perform convolutional image processing using light modulation and a pre-trained convolutional kernel, enabling operations at the speed of light.

### SUMMARY OF THE INVENTION

The invention provides a system and method for performing optical convolutional image processing by utilizing a spatial light modulator, such as a digital micromirror device (DMD) or liquid crystal display (LCD) panel, to emit spatially modulated light corresponding to an input image (101). This modulated light passes through a photosensitive film (102) embedded with a convolutional kernel, which modulates the amplitude of the light according to the kernel's spatial distribution. The modulated light is then projected onto an output plane (103), where the final image is formed as the convolution of the input image and the kernel. The final image formed on the output plane can be captured using a camera for further analysis or use.

The photosensitive film (102) serves as a physical embodiment of the convolutional kernel. This kernel is pre-trained for a specific image processing task, such as edge detection, blurring, or sharpening. The kernel is imprinted onto the photosensitive film through a process of photographic exposure (202). After exposure, the film is chemically developed (204) and fixed (205), creating a stable and durable spatially modulated filter that functions as the convolutional kernel.

The system enables real-time, high-speed image processing by leveraging the physical properties of light passing through the modulated film, effectively allowing convolutional operations to occur at the speed of light. This approach reduces the computational load on digital systems by shifting the convolution operation into the optical domain, offering potential advantages in speed and power efficiency.

### FIGURE DESCRIPTIONS

FIG. 1 illustrates the overall system setup for optical convolutional image processing. The diagram shows the light rays emitted from the input image source, represented by a spatial light modulator, labeled as element (101). The spatially modulated light passes through a photosensitive film, which is embedded with a convolutional kernel, marked as (102). As the light interacts with the kernel-embedded film, its amplitude is modulated based on the spatial distribution of the kernel. This modulated light then travels to the output plane, labeled as (103), where the final image is formed as the convolution of the input image and the kernel.

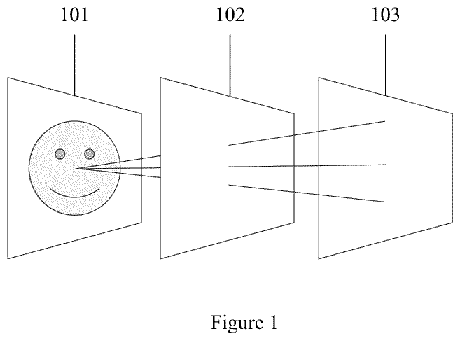

FIG. 2 is a flowchart representing the process of embedding the convolutional kernel onto the photosensitive film. The process begins with a pre-trained convolutional kernel, denoted as (201), which has been prepared in a digital environment for a specific image processing task. The photosensitive film, labeled as (203), is then exposed to a light pattern corresponding to the pre-trained kernel during the exposure step, marked as (202). After exposure, the film undergoes chemical development, indicated by (204), to stabilize the imprinted kernel. Finally, the film is fixed in a chemical fixing process, labeled as (205), ensuring the kernel remains stable and durable, forming a permanent spatially modulated filter on the film.

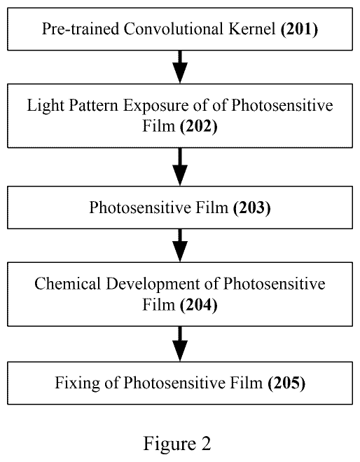

FIG. 3 presents a flowchart of the general workflow of the optical convolutional image processing method. The process begins with the input image source, labeled as (301), which generates the image to be processed. The next step involves spatial light modulation, marked as (302), where the input image is modulated using a spatial light modulator such as a DMD or LCD panel. The spatially modulated light then passes through the kernel-embedded photosensitive film, indicated by (303), where the convolution operation occurs. The modulated light forms the final image on the output plane, labeled as (304). This final convolved image can then be captured by a camera, indicated by (305), for further analysis or application.

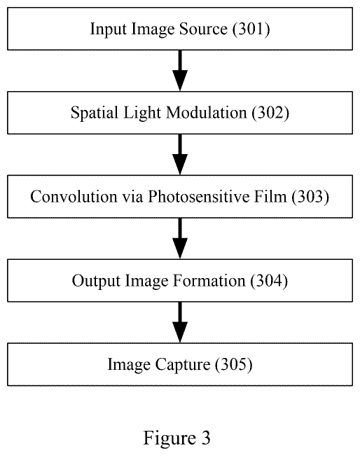

### DETAILED DESCRIPTION OF THE INVENTION

### 1. System Overview

The system comprises three main components: a spatial light modulator, a kernel-embedded photosensitive film, and an output plane (103). The spatial light modulator could be a digital micromirror device (DMD), a liquid crystal display (LCD) panel, or another advanced spatial light modulation system, which emits spatially modulated light representing the input image (101) to be processed. The modulated light then passes through the kernel-embedded photosensitive film (102), which is positioned between the light source and the convolution output plane.

### 2. Kernel-Embedded Photosensitive Film

The kernel-embedded photosensitive film (102) is a key element of the system. This film is a transparent or semi-transparent photosensitive material, such as silver halide film or photopolymer film, onto which a convolutional kernel is embedded. The kernel is typically pre-trained in a digital environment using machine learning techniques to perform a specific image processing task. Once trained, the kernel is transferred onto the photosensitive film using a photographic exposure process (202), where the film is exposed to a light pattern that corresponds to the convolutional kernel (201).

After exposure, the photosensitive film undergoes a chemical development (204) and fixing process (205) to stabilize the imprinted kernel. This results in a permanent, stable spatial modulation on the film that serves as the convolutional kernel. The developed and fixed film (102) is then used in the optical system to modulate light passing through it, effectively convolving the input image with the kernel at the speed of light.

### 3. Light Modulation and Convolution Process

When the spatially modulated light from the light modulator (101) passes through the kernel-embedded photosensitive film (102), the light's amplitude is modulated according to the spatial distribution of the kernel on the film. This modulated light represents the convolution of the input image with the kernel, and it is projected onto an output plane (103).

The light sensor, such as a CMOS sensor, captures the modulated light and converts it into a digital signal that can be further processed or displayed. Alternatively, the convolved image formed on the output plane (103) can be captured using a camera for further analysis or application (305).

### 4. Applications

The described system can be used in various applications, including but not limited to, real-time image processing, optical computing, augmented reality, and scientific imaging. It provides a method for offloading computationally intensive convolution operations from digital processors to an optical system, potentially increasing processing speeds and reducing power consumption.

### 5. Advantages

The invention offers several advantages over traditional digital convolution methods. By utilizing light modulation and physical convolutional kernels, the system can achieve real-time processing speeds that are difficult to match with purely digital systems. Additionally, the analog nature of the system allows for continuous, rather than discrete, modulation of light. The use of a photosensitive film as the convolutional kernel also provides a simple and cost-effective means of implementing different image processing tasks without the need for complex digital reconfiguration.

1. A system for optical convolutional image processing, comprising:
A spatial light modulator configured to emit spatially modulated light corresponding to an input image (101);
A photosensitive film (102) positioned in front of the spatial light modulator, wherein the film is embedded with a convolutional kernel by a process comprising:
Exposing the photosensitive film to a light pattern corresponding to a pre-trained convolutional kernel (201);
Chemically developing the exposed photosensitive film to stabilize the imprinted kernel (204);
Fixing the developed film (205) to ensure the stability of the kernel, thereby forming a stable, spatially modulated filter that modulates the amplitude of the light based on the spatial distribution of the kernel;
An output plane (103) positioned to receive the modulated light, wherein the final image result formed is the convolution of the input image and the kernel;
A camera configured to capture the final image formed on the output plane.

2. The system of claim 1, wherein the spatial light modulator is selected from the group consisting of a digital micromirror device (DMD), a liquid crystal display (LCD) panel, or another spatial light modulation system.

3. The system of claim 1, wherein the photosensitive film is embedded with the convolutional kernel through a photographic exposure process (202), followed by chemical development (204) and fixing (205) to stabilize the kernel on the film.

4. The system of claim 1, wherein the convolutional kernel is pre-trained for a specific image processing task selected from the group consisting of edge detection, blurring, sharpening, and feature extraction.

5. The system of claim 1, wherein the light sensor is a CMOS sensor that converts the modulated light into a digital signal for further processing or display.

6. The system of claim 1, wherein the output plane (103) displays the final convolved image directly for observation or projection onto another surface.

7. The system of claim 1, wherein the photosensitive film is replaceable, allowing for the use of different kernels for various image processing tasks.

8. A method for optical convolutional image processing, comprising the steps of:
Emitting spatially modulated light from a spatial light modulator corresponding to an input image (101);
Passing the modulated light through a photosensitive film (102) embedded with a convolutional kernel, wherein the embedding of the kernel comprises:
Exposing the photosensitive film to a light pattern corresponding to a pre-trained convolutional kernel (201);
Chemically developing the exposed photosensitive film to stabilize the imprinted kernel (204);
Fixing the developed film (205) to ensure the stability of the kernel, thereby forming a stable, spatially modulated filter;
Projecting the modulated light onto an output plane (103), wherein the final image result is the convolution of the input image and the kernel;
Capturing the final image formed on the output plane using a camera.

9. The method of claim 8, further comprising the step of replacing the photosensitive film with a different film to perform a different image processing task.
